(19) United States
(12) Patent Application Publication
(10) Pub. No.: US 2006/0181721 A1
(43) Pub. Date: Aug. 17, 2006

(54) Motion picture content preview

(76) Inventors: Manish S. Kulkarni, San Jose, CA (US); Lars U. Borg, Saratoga, CA (US)

Correspondence Address: FISH & RICHARDSON P.C., P.O. Box 1022, MINNEAPOLIS, MN, 55440-1022, US

(21) Appl. No.: 11/056,626

(22) Filed: Feb. 11, 2005

(51) Int. Cl. H04N 1/60

(52) U.S. Cl. 358/1.9

(57) ABSTRACT

A method is described for providing an accurate cinema screen preview of digitized image data. The method may determine an exposure range of print film using an encoding range and a color calibration reference. In addition, a sensitometric curve associated with the print film may be sampled over the exposure range to obtain a plurality of density samples. The density samples may be converted to transmittance samples and the transmittance samples may be encoded in a color profile. In some variations, the method may also determine transmittance spectra for CMY layers and RGB, determine XYZ values and encode the XYZ values in the color profile.

### TECHNICAL FIELD

The subject matter herein relates to data processing.

### BACKGROUND

The motion picture industry is increasingly relying on computer systems to modify and preview films. A typical motion picture workflow 100, as shown in FIG. 1, begins with a camera 110 recording a scene on a medium such as an original camera negative (OCN) for traditional cameras or digital media (e.g., optical or magnetic media) for digital cameras. A digitized representation of captured images may be then provided to a computer workstation 120. The workstation 120 may include one or more monitors on which the appearance of the digitized data can be previewed. Editorial modifications may be made and special effects may be added to the digitized data. Thereafter, for traditional film projectors, the digitized data (with the modifications and special effects) may be transferred to film for projection on a cinema screen 130. Alternatively, the digitized data may be transferred to a digital projector for projection on the cinema theater screen 130.

Any manipulations to the digitized data (e.g., computer rendered special effects, combinations of multiple footage from multiple scenes, etc.) during the workflows illustrated in FIG. 1 may affect the appearance of the film when projected on a cinema screen. As a result, certain scenes or special effects added to film frames may not adequately match the look and feel of previous film frames.

### SUMMARY

In one aspect, a method comprises determining an exposure range of print film using an encoding range and a color calibration reference, sampling a sensitometric curve associated with the print film over the exposure range to obtain a plurality of density samples, converting the density samples to transmittance samples, and encoding the transmittance samples within a color profile.

In some variations, the method may further comprise converting color values of digitized image data from a first color space (e.g., a color space simulating a cinema screen appearance) to a second color space (e.g., a color space associated with a viewing device) using the color profile. The color profile, for example, may be an INTERNATIONAL COLOR CONSORTIUM format color profile. The method may also include displaying the digitized image data on a display device such as a computer monitor. In addition, the encoding range may be based on a density range encoded by a digital format file, such as a DPX file.

The method may further comprise normalizing the transmittance samples to a fixed transmittance range before the encoding. The normalizing may, for example, take into account any parameters or other limitations associated with the color profile.

In another variation, the method may further comprise adjusting the transmittance samples by mapping a predetermined value to a reference gray value. The reference gray value may be, for example, in range of 10%-20% gray, and in some variations, 14% gray. The reference gray value may comprise a Laboratory Aim Density method reference value. The method may additionally or optionally comprise applying a gamma to the sampled sensitometric curve. In some variations, the color calibration reference comprises a Laboratory Aim Density patch.

The method may also comprise calculating cyan layer, yellow layer, and magenta layer transmittance spectra, calculating red, green, and blue transmittance spectra respectively using the magenta layer, yellow layer, and cyan layer transmittance spectra, calculating X, Y, and Z values based on a viewing illuminant spectra and respectively based on the red, green, and blue transmittance spectra, and respectively based on X, Y, and Z color matching functions, and encoding the X, Y, and Z values within the color profile. The color matching functions may be, for example, CIE color matching functions.

The transmittance spectrum may be determined based on an exposure value in a range of 1.8 to 2.4. In some variations, the exposure value may be approximately 2.0.

In one variation, the method may further comprise chromatically adapting the XYZ values to a D50 illuminant. Other chromatic adaptations may be implemented depending on the desired configuration.

In another aspect, an inter-related method comprises calculating cyan layer, yellow layer, and magenta layer transmittance spectra, calculating red, green, and blue transmittance spectra respectively using the magenta layer, yellow layer, and cyan layer transmittance spectra, calculating X, Y, and Z values based on a viewing illuminant spectra and respectively based on the red, green, and blue transmittance spectra, and respectively based on X, Y, and Z color matching functions, and encoding the X, Y, and Z values within a matrix in a color profile.

In yet another aspect, an apparatus comprises a determination unit to determine an exposure range of print film using an encoding range and a color calibration reference, a sampling unit to sample a sensitometric curve associated with the film over the exposure range to obtain a plurality of density samples, a conversion unit to convert the density samples to transmittance samples, and a first encoding unit to encode the transmittance samples within a color profile.

The apparatus may also comprise a calculation unit to calculate cyan layer, yellow layer, and magenta layer transmittance spectra, to calculate red, green, and blue transmittance spectra respectively using the magenta layer, yellow layer, and cyan layer transmittance spectra, to calculating X, Y, and Z values based on a viewing illuminant spectra and respectively based on the red, green, and blue transmittance spectra, and respectively based on X, Y, and Z color matching functions, and a second encoding unit to encode the X, Y, and Z values within the color profile. Additionally or in the alternative, the apparatus may further comprise a transformation unit to convert color values of digitized image data from a first color space (generated, for example, by the color profile) to a second color space using the color profile.

In yet another aspect, a computer program product, tangibly embodied in an information carrier, comprises instructions. The instructions may be operable to cause data processing apparatus to convert color values of digitized data from a first color space to a second color space using a color profile, wherein the color profile is generated by a method comprising determining an exposure range of film when illuminated using an encoding range and a color calibration reference, sampling a sensitometric curve associated with the film over the exposure range to obtain a plurality of density samples, converting the density samples to transmittance samples, and encoding the transmittance samples within a color profile.

The computer program product may also provide that the method to generate the color profile further comprises calculating cyan layer, yellow layer, and magenta layer transmittance spectra, calculating red, green, and blue transmittance spectra respectively using the magenta layer, yellow layer, and cyan layer transmittance spectra, calculating X, Y, and Z values based on a viewing illuminant spectra and respectively based on the red, green, and blue transmittance spectra, and respectively based on X, Y, and Z color matching functions, and encoding the X, Y, and Z values within the color profile.

Computer program products, which may be embodied on computer readable-material, are also described. Such computer program products may include instructions operable to cause data processing apparatus to conduct one or more of the method acts described herein. In one variation, a computer program product may include instructions to cause data processing apparatus to convert digitized color data using a color profile generated according to the techniques described herein.

Similarly, computer systems are also described that may include a processor and a memory coupled to the processor. The memory may encode one or more programs that cause the processor to perform one or more of the method acts described herein.

The subject matter described herein may be implemented to realize one or more of the following advantages. For example, the subject matter described herein enables an immediate preview of a cinema appearance on another device such as a computer monitor. This preview may be used to ensure that any changes in the digitized data during editing or due to special effects maintain a desired cinema appearance (i.e., the inserted scenes or special effects are seamlessly integrated). Moreover, the desired theater appearance may be maintained without complicated quality assurance procedures. For example, the digitized data need not be transferred to film (or transferred to a digital projector) and subsequently projected in a cinema in order to determine the effects of any artistic or editorial manipulations.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 illustrates a conventional motion picture workflow useful for understanding and implementing the subject matter described herein;

FIG. 2 illustrates a motion picture workflow useful for understanding and implementing the subject matter described herein;

FIG. 3 illustrates a first process flow diagram useful for understanding and implementing the subject matter described herein;

FIG. 4 illustrates a second process flow diagram useful for understanding and implementing the subject matter described herein;

FIG. 5 illustrates an apparatus to implement a process similar to that provided in FIG. 3 useful for understanding and implementing the subject matter described herein; and

FIG. 6 illustrates an apparatus to implement a process similar to that provided in FIG. 4 useful for understanding and implementing the subject matter described herein.

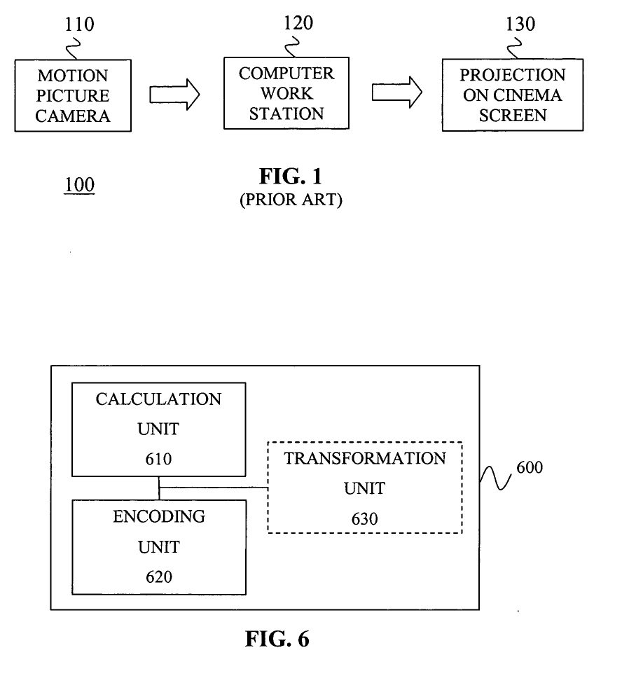

### DETAILED DESCRIPTION

While the following may describe the creation of an INTERNATIONAL COLOR CONSORTIUM (ICC) profile to encapsulate a transform required for a theater-like preview of a CINEON/Digital Picture exchange (DPX) format file on a computer monitor, it will be appreciated by the skilled artisan that other color profiles and other file formats may be utilized with similar characteristics.

ICC profiles provide a cross-platform device profile format. ICC profiles can be used to translate color data created on one device into the native color space of another device. Use of such color profiles allow end users to transparently move profiles and images with embedded profiles between different operating systems while maintaining color fidelity.

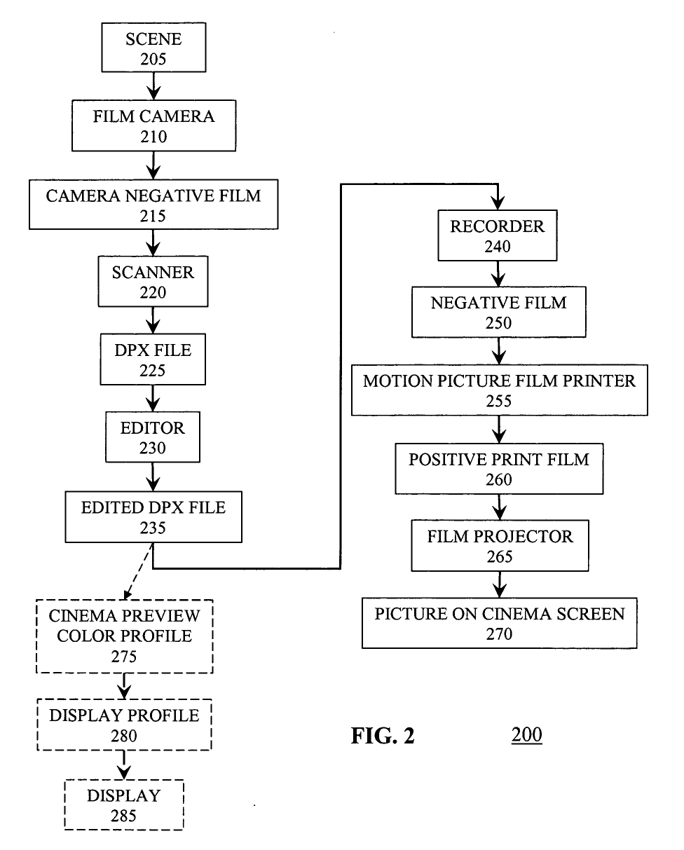

FIG. 2 illustrates a motion picture workflow 200 in which a scene 205 may be captured by a film camera 210 on camera negative film 215 (OCN). The camera negative film 215 may be scanned by a scanner 220 to generate a CINEON/Digital Picture exchange (DPX) format file 225. The DPX file 225 may be viewed and altered in an editor 230 to generate an edited DPX file 235. The edited DPX file 235 may then be transferred to negative film 250 by a recorder 240. Thereafter, the negative film 250 may be developed into a positive print film 260 by a motion picture film printer 255. The positive print film 260 may be loaded into a film projector 265 so that a picture may be projected onto a cinema screen 270. In some variations, a color management system may convert DPX colors to monitor colors using a cinema preview color profile 275 and a display color profile 280. The converted color values are used to simulate, on display 285, the appearance of film projected on a cinema screen without steps 240 to 270.

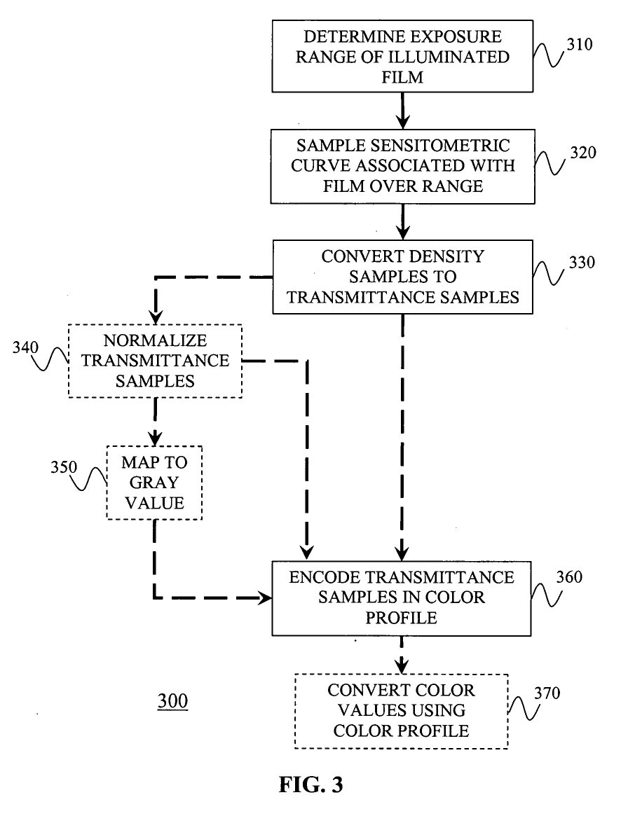

FIG. 3 illustrates a method 300 for generating three tone reproduction curves (TRCs) in a process flow diagram. FIG. 4 illustrates a method 400 for generating a matrix in a process flow diagram. In one variation, DPX RGB color space values may be converted to Commission Internationale de L'Eclairage (CIE) XYZ color space values using TRCs and a 3×3 Matrix to convert DPX R′G′B′ to XYZ. The data for such a conversion may be stored in a color profile such as a three-component Matrix-based color profile (e.g., an ICC Profile). DPX R′G′B′→[TRCs]→RGB[3×3 Matrix]→XYZ.

The following may be based on, for illustrative purposes, digitized data obtained from negative film by a CINEON/DPX system that may be illuminated by a projection system using a xenon light source. The digitized data may be in one of many standards including CINEON/DPX files. After the processing of the digitized data has been completed, the digitized data may be recorded back onto negative film which in turn is printed onto print film for projection onto a cinema screen. Alternatively, the digitized data may be provided to a digital projector and directly projected onto a cinema screen. Other print films, scanners, and illuminants may be utilized depending on the desired implementation. In particular, the subject matter described herein may also be used in connection with a workflow involving a digital camera and/or a digital projector.

A method 300 for generating a TRC is illustrated in FIG. 3. The TRC may be used to translate DPX code values (in a range, for example, of [0, 1023]) to relative radiometric intensity (in a range, for example, of [0, 1]). At step 310, an exposure range of print film may be determined. This determination may, for example, be based on a 2.046 relative log exposure range (as based on a default 2.046 density range encoded by DPX files) from a sensitometric curve associated with the print film. A sensitometric curve, also known as a characteristic curve, is a plot of density versus relative log exposure and indicates the response of film to each of red, green, and blue lights. A sensitometric curve typically has five regions, a minimum density portion, a toe portion, a straight-line portion, a shoulder portion, and a maximum density portion.

The number “exposure” represents an exposure level for the film that may not correlate to the exposure values described above. Exposure may be measured as the product of the time of exposure and the intensity of the illumination upon the sensitive surface (e.g., irradiance), exposure=i×t.

The digitized image file format may be a CINEON format file which stores data in ten bit density using printing densities. In some variations, file formats may be used that store data using Status M densities (which may, for example, be derived from printing densities). The CINEON image file format is a subset of the ANSI/SMPTE DPX file format. A CINEON/DPX format file consists of four parts: (i) a generic file information header having a fixed format, predefined, general information header consisting of several sections (generic, image, data format and image origination); (ii) a motion picture and television industry specific header having a fixed format, industry (television, film) specific header; (iii) user-defined information including variable length, user defined data; and (iv) image data.

The Laboratory Aim Density (LAD) print control method specifies that the DPX value of 445 (in the default 10-bit range [0, 1023]) maps to a Visual Density of 1.0 which corresponds to a Status A density of 1.06 for the green channel for Kodak 2383 print film (see, for example, Kodak Vision Color Print Film/2383, Publication No. H-1-2383t (September 1998)). Status A density is a reference measurement of photographic positive materials. Therefore, a DPX value of 445 may be used to determine the range to use from the sensitometric curve. With the LAD printing control method, a standard reference (or control) patch specifies densities between the minimum and maximum of those typically obtained for a normal camera exposure. A sample LAD control method is described in the paper John Pytlak et al., “A Simplified Motion-Picture Laboratory Control Method for Improved Color Duplication”, SMPTE Journal, Volume 85: 781-786 (1976).

For example, for Kodak 2383 print film, a Status A density (as defined in ISO 5-3) of 1.06 may be obtained using a sensitometric curve for a relative log exposure value of 0.714. From this exposure value, a range for DPX [0, 1023] may be determined to be exposure values [−0.442, 1.604] based on a reference point of 0.714 corresponding to a DPX value 445 and an increment size of 0.002 (as each increment in DPX count increases printing density by 0.002 and reduces log exposure by 0.002). While the foregoing only utilizes the green channel to compute three identical TRCs, in some variations, three different TRCs may be derived from the Status A RGB (1.09, 1.06, 1.03) target values. Such a variation would require gray-balance compensation.

At step 320, the sensitometric curve may be sampled in the exposure range determined in step 310. For example, a sensitometric curve may be sampled for a predetermined set of DPX values using the relationship between exposure and DPX value described above. In some variations, the number of samples may be equal to 1024 (using default DPX code values), however a greater or smaller sample interval may be used as desired. For Kodak 2383 print film, sampling the relative log exposure in the range [−0.442, 1.604] gives density samples (e.g., Status A density samples) in the range [0.0587, 3.979] (from the exposure range in the print film's sensitometric curve).

At step 330, the density samples (e.g., Status A density samples) may be converted to transmittance. Density may be defined for a given wavelength as an expression of the transmittance of an optical element. Density D is equal to log₁₀(1/T) where T is transmittance (so transmittance may be determined by T=10^{-D}).

Optionally, thereafter at step 340, the transmittance samples may be normalized. In one variation, the transmittance samples are each divided by the largest transmittance value. For example, if the desired color profile is an ICC profile, then the transmittance samples would be normalized to a range up to 1.

In addition, or in the alternative to the normalization of the samples, at step 350, the resultant TRC may be adjusted to map the LAD value to a reference gray value (e.g., a value from 10% gray to 20% gray, such as 14% gray) by applying a gamma to the curve. In some variations, tone mapping can be accomplished using a gamma curve such as output voltage=(input voltage)^{gamma}.

With Kodak 2383 print film, before gamma adjustments, the Y value at LAD is at 0.10. The gamma value may be determined to map this value to 0.14: gamma=log (0.14)/log (0.10)=0.85. With this arrangement output voltage=(input voltage)^{0.85}. Omitting this step results in different TRCs.

At step 360, the TRCs (which may optionally be normalized and/or adjusted by a gamma curve) may be encoded in the color profile. If the color profile is, for example, an ICC profile, then the TRCs may be encoded in rTRC, gTRC, and bTRC tags.

At step 370, color data in the digitized image data may optionally be converted from a first color space associated with the color profile established in step 360 to a second color space associated with a color profile for the monitor.

If the transmittance samples were not normalized, then there may be values greater than one when the digital image data is converted to the second color space. Therefore, the method may also include an additional post-processing step of mapping the resultant color values to the [0, 1] range or other desired range.

With reference to FIG. 4, a method 400 may create an additive RGB color space suitable for simulating a color gamut of a print film being projected in a cinema. The method 400 may commence, at step 410, with the determination of a transmittance spectrum for a cyan layer in the film using dye-density spectra. The dye-density spectra may be determined using a spectral density curve for the imaging dyes used in the film. The transmittance spectrum, Tc, for the cyan layer, may be determined as: Tc(λ)=10^{-exposure*Dc(λ)} where Dc is the cyan dye density spectrum for the film as a function of the wavelength λ. Both Dc (λ) and Tc (λ) may be sampled functions, sampled, for example, at 10 nm or finer, in the range [360, 750] nm. The transmittance spectra for the magenta and yellow layers may be respectively determined by Tm(λ)=10^{-exposure*Dm(λ)} where Dm is the magenta dye density spectrum for the film as a function of the wavelength λ, and Ty(λ)=10^{-exposure*Dy(λ)}, where Dy is the yellow dye density spectrum for the film as a function of the wavelength λ. Transmittance spectra for a three layer film comprises T(λ)=10^{-(CyanExposure*Dc(λ)+MagentaExposure*Dm(λ)+YellowExposure*Dy(λ)+UnexposedBase(λ))}. In some variations, the unexposed base can be assumed to have density equal to zero.

Exposure value may depend on how the dye-density curves were normalized and a desired color saturation on a preview display (e.g., computer monitor). For example, exposure values in the range of 1.4 to 2.4, and more particularly a value of approximately 2.0 may be used to achieve a desired color saturation.

An additive RGB color space is built on three primary colors, red, green, and blue. On film (which is a medium with a subtractive color model), a red color may be obtained by exposing magenta and yellow dye layers. Green color may be obtained by exposing cyan and yellow dye layers. Blue color may be obtained by exposing cyan and magenta layers.

At step 420, the transmittance spectra for red, green, and blue may be determined using, for example, the following formulas:
Tr(λ)=Tm(λ)*Ty(λ)
Tg(λ)=Ty(λ)*Tc(λ)
Tb(λ)=Tc(λ)*Tm(λ)

At step 430, XYZ values for RGB transmittances may be calculated using a viewing illuminant spectrum (e.g. a xenon illuminant spectrum) and CIE XYZ color matching functions (e.g., CIE 1931 2 degree XYZ color matching functions). These values may be determined, for example, using the following formulas:
Xr=∫Mx(λ)*L(λ)*Tr(λ)
Yr=∫My(λ)*L(λ)*Tr(λ)
Zr=∫Mz(λ)*L(λ)*Tr(λ)
Xg=∫Mx(λ)*L(λ)*Tg(λ)
Yg=∫My(λ)*L(λ)*Tg(λ)
Zg=∫Mz(λ)*L(λ)*Tg(λ)
Xb=∫Mx(λ)*L(λ)*Tb(λ)
Yb=∫My(λ)*L(λ)*Tb(λ)
Zb=∫Mz(λ)*L(λ)*Tb(λ)
Where Mx (λ), My (λ) and Mz(λ) may be CIE XYZ color matching functions (e.g., CIE 1931 2 degree XYZ color matching functions). L (λ) may be the illuminant spectrum.

At step 440, the obtained XYZ values may be encoded in the color profile (e.g., encoded in rXYZ, gXYZ, and bXYZ tags). Optionally, and if the color profile is an ICC profile, at step 450, the XYZ values may be chromatically adapted to CIE Illuminant D50 before encoding. D50 is a reference illuminant that defines the spectral distribution of daylight with a color temperature of 5003 K (see, for example, ISO 3664 for practical appraisal or prints). With D50, the energy of the blue, green, and red portions of the spectrum may be approximately equal.

One sample technique for chromatic adaptation is as follows. A matrix M_{c} of red, green, and blue chromaticities is populated using the following formulae:
xr=Xr/(Xr+Yr+Zr)
yr=Yr/(Xr+Yr+Zr)
zr=1−xr−yr
xg=Xg/(Xg+Yg+Zg)
yg=Yg/(Xg+Yg+Zg)
zg=1−xg−yg
xb=Xb/(Xb+Yb+Zb)
yb=Yb/(Xb+Yb+Zb)
zb=1−xb−yb
The Matrix M_{c} may be represented by:

$${M}_{c} = \vert \begin{matrix}xr xg xb \\ yr yg yb \\ zr zg zb\end{matrix} \vert$$

White tristimulus values Wₜ may be computed using the following formulae:
Xw=∫L(λ)*Mx(λ)
Yw=∫L(λ)*My(λ)
Zw=∫L(λ)*Mz(λ)
The tristimulus values may be normalized so that Yw equals 1 by dividing Xw, Yw and Zw by Yw.

The white tristimulus values may be represented by:

$${W}_{t} = \vert \begin{matrix}Xw \\ Yw = 1 \\ Zw\end{matrix} \vert$$

A matrix corresponding to white M_{w} may be calculated as:

$$S = \vert \begin{matrix}a \\ b \\ c\end{matrix} \vert = Inverse ( M ) * W$$

$${S}_{d} = \vert \begin{matrix}a & 0 & 0 \\ 0 & b & 0 \\ 0 & 0 & c\end{matrix} \vert$$

$${M}_{w} = M * {S}_{d}$$

A matrix M_{f} may be computed corresponding to D50 using Bradford chromatic adaptation.
M_{f}=M_{adapt}*M_{w}
where M_{adapt} is computed as described in Annex E of INTERNATIONAL COLOR CONSORTIUM Specification ICC.1:2004-10, (Profile version 4.2.0.0), Image technology colour management—Architecture, profile format, and data structure [REVISION of ICC. 1:2003-09]. With this Matrix M_{f}, the XYZ values maybe chromatically adapted so that they are compatible with an ICC profile

At step 460, a cinema appearance is obtained by converting the DPX code values to XYZ tristimulus values using the color profile. In cases where the processes illustrated in FIGS. 3 and 4 are combined, the color data need only be converted once after encoding the transmittance samples and the XYZ values in the color profile.

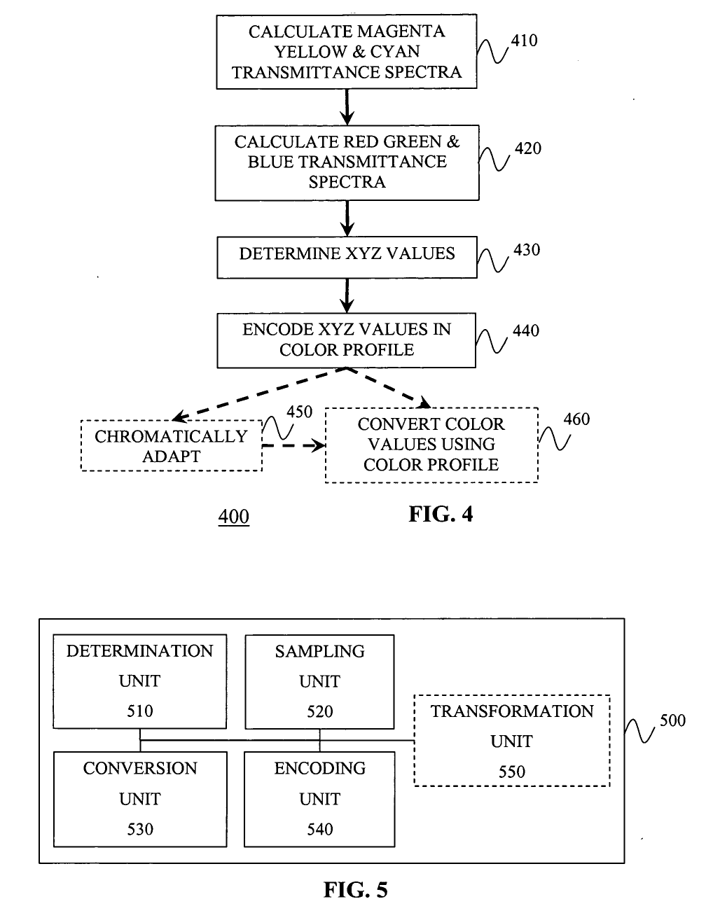

FIG. 5 illustrates an apparatus 500 that may be used to simulate a color output of a cinema projector on, for example, a computer monitor. A determination unit 510 determines an exposure range of film when illuminated using a color calibration reference. A sampling unit 520 samples a sensitometric curve associated with the film over the exposure range (determined by the determination unit 510) to obtain a plurality of density samples. A conversion unit 530 converts the density samples obtained by the sampling unit 520 to transmittance samples. An encoding unit 540 encodes the transmittance samples from the sampling unit 520 within a color profile. A transformation unit 550, which is optional and may be external to the apparatus 500, converts color values from the digitized image data from a first color space (e.g., a color space simulating an appearance of a cinema screen) to a second color space (e.g., a color space associated with a monitor or other viewing device) using the color profile.

FIG. 6 illustrates an apparatus 600 that may be standalone or may be integrated into the apparatus of FIG. 5. A calculation unit 610 calculates cyan layer, yellow layer, and magenta layer transmittance spectra. The calculation unit 610 also calculates red, green, and blue transmittance spectra respectively using the magenta layer, yellow layer, and cyan layer transmittance spectra. In addition, the calculation unit 610 calculates X, Y, and Z values based on a viewing illuminant spectra and respectively based on the red, green, and blue transmittance spectra, and respectively based on X, Y, and Z color matching functions. An encoding unit 620 encodes the X, Y, and Z values from the calculation unit 610 within a color profile. A transformation unit 630, which is optional and may be external to the apparatus 600, converts color values within the digitized image data from a first color space to a second color space using the color profile.

It will be appreciated by the skilled artisan that the apparatus of FIGS. 5 and 6 may comprise separate units or a single device integrating all of the units. In addition, the skilled artisan will recognize that different coupling configurations may be used to connect the units (i.e., the units may be connected in a serial fashion, etc.). Moreover, If the apparatus of FIGS. 5 and 6 are combined, then a single encoding unit 540, 620 and a single transformation unit 550, 630 may be utilized.

The subject matter described herein and all of the functional operations described in this specification can be implemented in digital electronic circuitry, or in computer software, firmware, or hardware, including the structural means disclosed in this specification and structural equivalents thereof, or in combinations of them. The subject matter described herein can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple processors or computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described herein has been described in terms of particular embodiments. Other embodiments are within the scope of the following claims. For example, the steps of the subject matter described herein can be performed in a different order and still achieve desirable results.

A number of variations of the subject matter described herein have been described. The skilled artisan will recognize that the subject matter described herein may be applied to any intermediate format digitized data in which it may be desirable to simulate the appearance of another viewing device (or system). Nevertheless, it will be understood that various modifications may be made without departing from the scope of the subject matter described herein. Accordingly, other variations are within the scope of the following claims.

What is claimed is:

1. A method comprising:
determining an exposure range of print film using an encoding range and a color calibration reference;
sampling a sensitometric curve associated with the print film over the exposure range to obtain a plurality of density samples;
converting the density samples to transmittance samples; and
encoding the transmittance samples within a color profile.

2. A method as in claim 1, further comprising converting color values of digitized image data from a first color space to a second color space using the color profile.

3. A method as in claim 1, further comprising normalizing the transmittance samples to a fixed transmittance range before the encoding.

4. A method as in claim 1, wherein the color profile conforms to an INTERNATIONAL COLOR CONSORTIUM profile format.

5. A method as in claim 4, wherein the transmittance samples are encoded in rTRC, gTRC, and bTRC tags of the color profile.

6. A method as in claim 1, further comprising adjusting the transmittance samples by mapping a predetermined value to a reference gray value.

7. A method as in claim 6, wherein the reference gray value is selected from a range of 10% gray to 20% gray.

8. A method as in claim 6, wherein the reference gray value comprises a Laboratory Aim Density method reference value.

9. A method as in claim 6, wherein the adjusting comprises applying a gamma to the sampled sensitometric curve.

10. A method as in claim 1, wherein the color calibration reference comprises a Laboratory Aim Density patch.

11. A method as in claim 1, wherein the encoding range is based on a density range encoded by a DPX file.

12. A method as in claim 1, further comprising:
calculating cyan layer, yellow layer, and magenta layer transmittance spectra;
calculating red, green, and blue transmittance spectra respectively using the magenta layer, yellow layer, and cyan layer transmittance spectra;
calculating X, Y, and Z values based on a viewing illuminant spectra and respectively based on the red, green, and blue transmittance spectra, and respectively based on X, Y, and Z color matching functions; and
encoding the X, Y, and Z values within the color profile.

13. A method as in claim 12, wherein the transmittance spectrum are determined based on an exposure value in a range of 1.8 to 2.4.

14. A method as in claim 13, wherein the exposure value is substantially 2.0.

15. A method as in claim 12, further comprising chromatically adapting the XYZ values to a D50 illuminant.

16. A method as in claim 12, wherein the color matching functions are CIE color matching functions.

17. A method as in claim 2, further comprising displaying the digitized image data on a monitor.

18. A method as in claim 1, further comprising scanning a film negative to generate the digitized image data.

19. A method comprising:
calculating cyan layer, yellow layer, and magenta layer transmittance spectra;
calculating red, green, and blue transmittance spectra respectively using the magenta layer, yellow layer, and cyan layer transmittance spectra;
calculating X, Y, and Z values based on a viewing illuminant spectra and respectively based on the red, green, and blue transmittance spectra, and respectively based on X, Y, and Z color matching functions; and
encoding the X, Y, and Z values within a matrix in a color profile.

20. An apparatus comprising:
a determination unit to determine an exposure range of print film using an encoding range and a color calibration reference;
a sampling unit to sample a sensitometric curve associated with the print film over the exposure range to obtain a plurality of density samples;
a conversion unit to convert the density samples to transmittance samples; and
a first encoding unit to encode the transmittance samples within a color profile.

21. An apparatus as in claim 20, further comprising:
a calculation unit to calculate cyan layer, yellow layer, and magenta layer transmittance spectra, to calculate red, green, and blue transmittance spectra respectively using the magenta layer, yellow layer, and cyan layer transmittance spectra, to calculating X, Y, and Z values based on a viewing illuminant spectra and respectively based on the red, green, and blue transmittance spectra, and respectively based on X, Y, and Z color matching functions; and
a second encoding unit to encode the X, Y, and Z values within the color profile.

22. An apparatus as in claim 21, further comprising a transformation unit to convert a color values of digitized image data from a first color space to a second color space using the color profile.

23. A computer program product, tangibly embodied in an information carrier, comprising instructions operable to cause data processing apparatus to:
convert color values of digitized data from a first color space to a second color space using a color profile, wherein the color profile is generated by a method comprising:
determining an exposure range of print film using an encoding range and a color calibration reference;
sampling a sensitometric curve associated with the print film over the exposure range to obtain a plurality of density samples;
converting the density samples to transmittance samples; and
encoding the transmittance samples within a color profile.

24. A computer program product as in claim 23, wherein the method to generate the color profile further comprises:
calculating cyan layer, yellow layer, and magenta layer transmittance spectra;
calculating red, green, and blue transmittance spectra respectively using the magenta layer, yellow layer, and cyan layer transmittance spectra;
calculating X, Y, and Z values based on a viewing illuminant spectra and respectively based on the red, green, and blue transmittance spectra, and respectively based on X, Y, and Z color matching functions; and
encoding the X, Y, and Z values within the color profile.
